(19) United States
(12) Patent Application Publication
(10) Pub. No.: US 2007/0183746 A1
(43) Pub. Date: Aug. 9, 2007

(54) System and method for controlling provision of content over a television network

(75) Inventors: Anthony Haeuser, Aurora, IL (US); Mary McCarthy, San Antonio, TX (US); Scott Pettit, San Antonio, TX (US); Christopher A. Lee, San Antonio, TX (US); Ross Cox, Cummin, GA (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/348,966

(22) Filed: Feb. 7, 2006

(51) Int. Cl. H04N 5/91

(52) U.S. Cl. 386/94

(57) ABSTRACT

The present disclosure provides a system and method for controlling recording of content delivered over a television network. The method includes receiving content over a television network corresponding to a customer identifier, receiving an input corresponding to the customer identifier to block a selected content from recording on a recording device, and blocking the recording of the selected content in response to the received input. The method also may block the recording of the selected content corresponding to any other account associated with the customer identifier. The method may further enable viewing of the selected content on a television set while the content is being blocked from recording.

### BACKGROUND OF THE DISCLOSURE

1. Field of the Disclosure

The present disclosure relates generally to the provision of television services over a television network.

2. Background

Television services provided over a television network, such as an Internet Protocol Television (IPTV) network, cable network or satellite network, include various content such as content over multiple channels, Video-on-Demand (VoD), Voice over Internet Protocol (VoIP), data from the Internet, etc., to customers over a broadband connection. The broadband connection typically terminates at a Set Top Box (STB) located at a customer premise. The STB may be coupled to a television set as well as to additional devices, such as a Digital Video Recorder (DVR). A DVR is a device that records video to a digital storage medium, such as a hard disk, in digital form, thereby enabling a viewer to record a show at a given time to be played back at another time, pause live TV shows, and skip advertising, among other things. In addition to the multiple content available, IPTV provides various features to a customer's viewing experience, such as an ability to purchase items through a television set, an integration of television viewing and Internet usage, interactive games, etc.

The STB typically operates a set of features that affect the viewer experience. Some typical features include parental control settings that enable a customer (also referred herein as “supervisor”) to restrict the content that may be viewed at a customer location. Often, a customer may have several STBs, each controlling a separate television. Each STB typically has a separate identifier and may be controlled by a separate personal identifier number (PIN).

Recording devices in conjunction with set-top-boxes are often utilized to record content delivered over the television networks. However, the content available over the television networks includes a wide variety, such as content categorized not suitable for certain age groups, VoD, pay-per-view, sexually explicit content, etc. Customers may desire to control the recording of some of such content delivered to the customer devices, such as the STBs. Thus, there is a need for a system and method for controlling the recording of certain television content.

### BRIEF DESCRIPTION OF THE DRAWINGS

For detailed understanding of the present disclosure, references should be made to the following detailed description of an exemplary embodiment, taken in conjunction with the accompanying drawings, in which like elements have been given like numerals, wherein:

FIG. 1 shows an exemplary high level functional diagram of a network for providing Internet Protocol Television (IPTV) services according to one embodiment of the present disclosure;

FIG. 2 illustrates an exemplary screenshot displaying options available to a supervisor through an interface accessible by a Set Top Box (STB) or a remote device;

FIG. 3 illustrates an exemplary screenshot for making changes to parental control settings;

FIG. 4 shows an exemplary screenshot of parental control settings of an individual account;

FIG. 5 shows an exemplary screenshot of a main programming guide;

FIG. 6 shows an exemplary screenshot of a Favorites list as seen on a television set without parental control settings;

FIG. 7 shows an exemplary screenshot of a Favorites list with parental control settings applied;

FIG. 8 shows an exemplary report on viewer activity that may be provided in one aspect of the present disclosure; and

FIG. 9 is a diagrammatic representation of a machine in the form of a computer system within which a set of instructions, when executed, may cause the machine to perform any one or more of the methodologies discussed herein.

### DETAILED DESCRIPTION OF THE DISCLOSURE

In view of the above, the present disclosure through one or more of its various aspects and/or embodiments is presented to provide one or more advantages, such as those noted below.

The present disclosure provides a system, method and computer programs to control recording of television content. In one aspect, the disclosure provides a computer-readable medium that is accessible to a processor for executing instructions contained in a computer program, wherein the computer program includes instructions to receive content over a television network for display on a television set corresponding to a customer identifier; instructions to receive an input corresponding to the customer identifier to block a selected content from recording on a recording device; and instructions to block the selected content from recording on the recording device in response to the received input. In another aspect, the computer program further may include instructions to display the selected content on a television set while blocking the same content from the recording device. The computer program further contains instructions to confirm the customer identifier before blocking the selected content from recording on the recording device. The content selected for blocking may be content having a certain rating, a video-on-demand (VOD); a pay-per-view (PPV) program; a content associated with an age group; a content delivered during a certain time period of a day; a specific type of a show; a selected television channel; and content that has an associated monetary amount. Additionally, the input to block the selected content may be received from a remote control associated with a set-top-box (STB), cellular telephone, personal digital assistant (PDA), computer via the internet or an Interactive Voice Recognition System. The customer identifier may be a primary account and may have one or more associated sub-accounts or identifiers. The computer program may further include instructions to automatically block the selected content from recording corresponding to one or more of the sub-accounts.

In another aspect, the disclosure provides an apparatus that includes: a first interface that provides content to a television set corresponding to a customer identifier; a second interface that provides the content to a recording device; and a processor that executes instructions contained in a computer program accessible to the processor, wherein the computer program includes: instructions to receive an input corresponding to the customer identifier to block a selected content from recording on a recording device; and instructions to block the recording of the selected content in response to the input. In one aspect, the recording device may be integral to the apparatus.

In another aspect, the apparatus may display the selected content on the television set while blocking the selected content from recording on the recording device. In another aspect the apparatus includes a memory that stores a list of programs that constitutes the selected content and a list of programs available for viewing on the television set. The processor of the apparatus further may unblock the selected content or a portion thereof in response to an input corresponding to the customer identifier. The input may be received from any suitable device, including a remote control associated with the apparatus, cellular telephone, PDA, and computer via the internet.

In yet another aspect, the disclosure provides a computer program that includes instructions to receive television content from a network corresponding to a customer identifier, instructions to record a selected content from the received content in response to a first input corresponding to the customer identifier, and instructions to block at least a portion of the recorded content from displaying on a television set in response to a second input corresponding to the customer identifier. The computer program may further include instruction to unblock at least a portion of the recorded content in response to a third input corresponding to the customer identifier.

In yet another aspect, the disclosure provides a system for providing a television service that includes: a database that stores customer information, including a customer identifier; a server linked to a Customer Premise Equipment (CPE); and a computer-readable medium accessible to the server to execute instructions contained in a computer program embedded in the computer-readable medium, wherein the computer program includes instructions to receive an input from a remote device corresponding to the customer identifier to block a selected content from recording on a recording device associated with the CPE; and instructions to block the selected content from recording on the recording device.

In yet another aspect, a method for controlling television content is provided, which includes: receiving content over a television network for providing the content to a television set corresponding to a customer identifier; receiving an input corresponding to the customer identifier to block recording of a selected content on a recording device; and blocking the recording of the selected content from recording on the recording device.

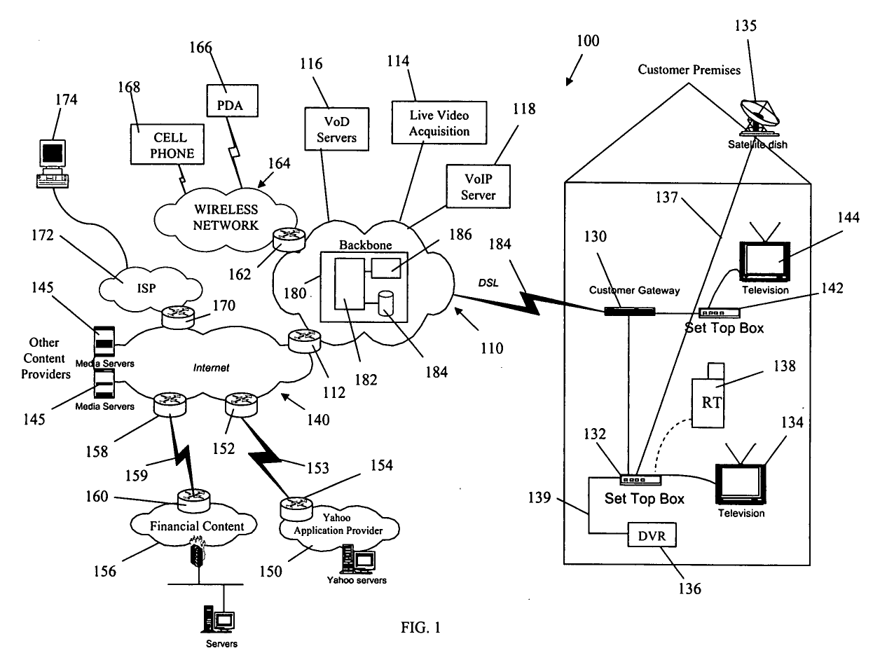

FIG. 1 shows an exemplary high-level functional diagram of a network 100 for providing television services according to one embodiment of the present disclosure. The network 100 is shown to include a backbone 110 that may be coupled to the Internet 140 via one or more routers, such as a router 112. The backbone may provide at least one of IPTV services, cable television service, and satellite television service to customers as well as content available through the Internet. Such content includes video and audio content. The backbone also may include a variety of servers, routers and transport links for obtaining and processing content. The backbone 110 is shown coupled to a system or elements of a live television content provider 114 for live video acquisition, that may include multiple television channels, such as is commonly delivered over television networks. The backbone 110 also is shown to include Video-on-Demand (VoD) servers 116 that provide Video-on-Demand to customers. Such servers include associated databases that store a variety of video content, such as movies, shows etc., that can be delivered to customers upon request. The backbone 110 is also shown to include a Voice over Internet Protocol (Voice over IP, or VoIP) server 118 that provides telephony service over a packet-switched network using a suitable protocol, such as VoIP. The backbone 110 is shown coupled via a Digital Subscriber Line (DSL) 184 to a customer gateway, such as a modem 130, which may be coupled to one or more set-top-boxes (STBs), such as STB 132 and STB 142, that are connected to television (TV) sets 134 and 144, respectively. Alternatively, the backbone network may couple via a satellite network to satellite dish 135 located at the customer location, which transmits content to the customer devices via a link 137. On the other hand, the backbone 110 may provide the content via a cable, such as coaxial cable or any other suitable link. The STBs may act as control interfaces for the respective TV sets and may be accessed by remote control, such as remote control 138. In addition, a recording device, such as Digital Video Recorder (DVR) 136 may be connected to an STB, such as STB 132, for the purpose of recording the content. The recording device 136 may be a separate device from the STB and connected thereto via a physical link or may be a module integrated into the STB. Also, the STB and/or recording device functions may be integrated into a television set. For the purposes of the disclosure, a DVR is discussed, but it is understood that the disclosure may be applied to any suitable recording device.

The backbone 110 is further shown coupled to a number of content providers over the Internet 140. For example, the backbone 110 is shown coupled to an Internet service provider (such as “Yahoo” Application provider) 150 via routers 152 and 154, and link 153; and a financial content provider 156 that may provide a financial service, such as customer investment portfolio information and/or enable a customer to order products and services from one or more vendors via the STB 132, via routers 158 and 160, and link 159. Similarly, the backbone 110 may be coupled to or have access to any other partner content provider (generally designated by numeral 145), such as an interactive service that enables a customer to play games against other players via a television, and a gaming service that enables a customer to bet online and settle accounts.

Still referring to FIG. 1, the backbone network 110 includes a system 180 that contains one or more servers 182, one or more databases, such a database 184, and a set of computer programs 186 which contain instructions that are executed by the server 182 to perform certain methods and functions described herein. The system 180, in on aspect, may store information relating to customers, interface with the customer devices and other systems that provide the various content over the network 100 to provide and/or control the content as specified by the customer via the customer input corresponding a customer identifier. In the exemplary network 100, customers, in one aspect, receive the content from the backbone network corresponding to an account set up with the service provider. A customer may have several STBs, each STB having a unique identifier. The content is typically provided to a common customer location from where it may be distributed to each STB. The network 100 may control the delivery of the content via the STBs that are registered or identified to the network. In one aspect, a customer may select or be provided with a master or first personal identification number (PIN) and may select sub-accounts or PINs. The master PIN may control selected operations of each STB of the customer and the sub-PINs may be associated with other individual STBs. Thus each STB can store and confirm the associated PINs. Such PINs may be communicated to the network for storage in the database, such as database 184, and/or reside in the STBs. The master PIN may be utilized to set or remove controls over each of the STBs from a single STB or a remote device, such as a cell phone, PDA or computer via the Internet, as described in more detail later. The PINs also may be utilized to separately control their associated STBs. Thus, in one aspect, the master PIN may be used to globally set controls for any or all of the STBs and also to remove such controls globally. In another aspect, the system and programs provided herein integrate controls for multiple operations related to content supported over the network 110 to the customer locations, such as controls for television viewing; controls for VoD ordering and viewing; controls related to playing games over the network; controls over VoIP usage; controls related to purchases made over the network; controls relating to pay-per-view ordering, controls for recording and viewing content; and controls for interactivity via the television, etc.

The customer information stored in the STBs and/or database 184 may include settings related to operations of one or more STBs at a customer location. These settings may include PINs, serial numbers of STBs or other identifier, content recording capabilities, parental control of content available to viewers at a TV set, DVR or suitable recording device, blocked channels or content, a list of favorite channels or most commonly visited channels (‘Favorites’) of a customer, as well as information related to broadband and voice service, including VoIP, and credit card numbers that may be charged for interactive activity by the customer, such as for buying merchandise, downloading videos, settling accounts, etc. In one aspect, the database 184 may store settings related to an STB, and these settings may be applied to content at the backbone 110. In another aspect, the STB may store the settings and the server 182 may receive the settings from the STB at a given time, such as on a scheduled basis, or upon request or query by the server 182 and store the settings in the database 184. In yet another aspect, settings for the STB may be shared between the database 184 and the STB. The settings may be associated with the STB by an IP address, an identifier associated with the STB, or any other suitable identifier.

Still referring to FIG. 1, the backbone 110 is further shown coupled to a wireless network 164, such as a cellular network for cellular communication via a router 162. The wireless network 164 may be accessed by various remote devices enabled for wireless communication, such as cell phone 168 and Personal Digital Assistant (PDA) 166. The Internet 140 is further shown coupled to an exemplary network of an Internet Service Provider (ISP) 172 that may provide Internet services to a remote device, such as computer 174, which may be connected to the ISP 172 via router 170. A customer using these exemplary remote devices may access settings stored at database 184 and initialize or otherwise change the settings. For example, a customer may initialize settings for an STB, such as setting up an account for parental controls, or make changes to settings, such as changing parental control settings. In another example, the customer may remotely program an STB, such as to record a program or to order a program from the VoD server 116. The system 180 also includes one or more computer programs 184 that are executed by the server 182 to perform the methods and functions described herein. The computer program may be distributed and reside in any suitable computer readable media accessible to the server.

Still referring to FIG. 1, content ratings associated with programs accessible to or embedded on a computer-readable medium located at the STB may also enable the parental control mechanism described herein. Parental controls may be used to block a viewer's access to video content such as regular TV programming and to purchases, such as a VoD or pay-per-view (PPV) programs, as well as to block recording content at a DVR or other recording device. In a typical customer location, where parental controls are used, a TV viewer may be assigned a viewer account that has an associated Personal Identification Number (PIN). The viewer may have several functions enabled through the account. For example, the viewer may be able to create a personal list of channels that are most often viewed (‘Favorites’). The viewer may be asked to enter a PIN number when interacting with the television set, such as when viewing certain content, or when purchasing video content from the network, such as VoD or PPV, or when purchasing an item, such as a ordering a book through a website, using the television set, or when recording content. Typically, one of the viewer accounts is given supervisory powers over the other viewer accounts and may be accessed by an account supervisor. The account supervisor may perform various functions, such as setting the PINs of the other viewers, controlling the video content that may be viewed by other viewers, monitoring the activities of other viewers, etc. The account supervisor may choose to set up categories of viewer accounts, such as ‘Teens’ and ‘Children,’ assign a viewer account to one of these categories, and supervise the activities of the viewer account indirectly through supervision of the category. Alternatively, the supervisor may choose to supervise a viewer account directly. The supervisor may apply global settings to all viewers or to categories of viewers rather than setting the parental controls of each viewer individually. Additionally, if a customer premise has more than one STB, the supervisor may set settings for all STBs from one location or at each STB individually. In one example, using parental controls, a channel, show, or purchase may be blocked at a TV in one room, yet be available at a TV in another room. The setting may be unblocked globally or via individual STBs.

Still referring to FIG. 1, a customer may create settings based on television content ratings. There are various rating systems available for use in parental control. One common rating system is provided by Motion Picture Association of America (MPAA) and uses the symbols G, PG, PG-13, R, NC-17, X to indicate recommended ages for viewing the content. Another common content rating system is the TV ratings system provided by the television industry and includes symbols such as TV-Y (for young children), TV-Y7 (directed toward older children), TV-G (directed towards a general audience), TV-PG (parental guidance suggested), TV-14 (parents strongly cautioned of strong material), and TV-MA (for mature audiences only). In addition, content having a rating of TV-PG, TV-14, and TV-MA may also have additional ratings, such as a “V” for violence, “S” for sexual content, “L” for language, or “D” for suggestive dialog, and “FV” for fantasy violence or cartoon violence.

One aspect of the present disclosure provides a computer program that includes instruction that affect settings related to the type of content, such as television programming from a network, VoD and pay-per-view (PPV) programming from a network, viewable at a CPE device, such as a television set, to content recorded to a recording device, such as a DVR, and to content purchasable via an interaction between a viewer and the television via a controlling device, such as a STB. Purchasable content may include VoD, PPV, or other viewable content, or a consumer item such as a book that may be purchased via an interaction between a viewer and the STB. The computer programs may operate at a suitable place within the system, such as at the STB 132, system 180 or another processor located at the network backbone 110.

In another aspect, parental control settings may be applied separately for content viewed at a television set and for content directed to a recording device. Thus, a viewer may have one set of parental control enabling him to watch R- and X-rated movies at the television set and another set of parental controls preventing him from recording those same R- and X-rated movies to a DVR or other recording device. In another aspect, the computer-readable medium may provide a program to block purchases that may be made via the STB, such as a book purchase. In another aspect, the settings, including parental controls, may be applied using variety of criteria to affect content. For example, a parental control setting may be set to block video content according to the program (such as ‘CSI’), to block a designated channel (such as HBO), to block a type of content (such as programs that contain sexual content), etc. Any suitable ratings system available in the industry, such as MPAA ratings, V-chip ratings, game ratings, etc., may be used. Changes in settings may be made to individual viewer accounts, or to groups of viewer accounts. Also, a change may be made universally to all viewer accounts. Parental control settings may be unlocked for all viewers for a specifiable period of time.

In another aspect, a monetary limit on items purchased via the television may be enforced over a time period, such as on weekly basis, a monthly basis, etc. In one example, purchases made within that time period may be made without entering a PIN number. However, once the purchase limit is reached, the viewer may be asked to enter a PIN number for approval of the purchase. Settings may be temporarily altered for a selected period of time without having to make changes to the current settings. For example, if parents are gone for a weekend, they may increase the restriction level of parental controls for that period of time. In addition, settings may be modified on behalf of the customer through a suitable notification method, such as by entering data into a Customer Service Request (CSR) form supplied at a web page, or by selecting settings over a telephone interaction with an Interactive Voice Recorder (IVR) that generally provides the caller with a set of options and provides a service in response to an input by the caller.

In another aspect, the disclosure provides channel blocking from a available channels, such a main programming guide. Although, the main programming guide may display all channels provided, a channel may be blocked at the main programming guide at one or more of the STB, from a single STB or from any other remote device such as a cell phone, PDA and computer. If a channel is blocked from the main programming guide, the main guide may display all of the network channels except the blocked channels from one or all STBs. The channel blocked on the main guide corresponding the master PIN may automatically block that channel from one or more selected sub-accounts or PINs. Alternatively, the main guide may display all available channels and change some aspect of the appearance of the name of the blocked channel to indicate the blocked status. For example, the name of the blocked channel may appear using a different shading or by using italics, etc. Any number of ways of altering the appearance may be used. The appearance of the main programming guide may be customized according to the television set it is viewed on. For example, if a channel is blocked from viewing at a first television set, yet is not blocked from viewing at a second television set, the blocked channel may not appear on the main programming guide when viewed at the first television set, yet appears on the main programming guide when viewed at the second television set.

Another aspect of the present disclosure provides for selecting channels (Favorites) by a viewer from the main programming guide. The ‘Favorites’ list generally includes those channels most frequently visited by a viewer and may be limited to a pre-determined maximum number of channels (i.e., 20 channels). Channels may include several content, such as programming, VoD, Internet, purchasing, and other channels. Multiple ‘Favorites’ lists may be provided to a STB or to a related database at the network to address multiple viewers at common or separate TV sets. Additionally, a single ‘Favorites’ list may have a different appearance when receive at two TV sets having different parental control settings. In one aspect, the viewer may push a button on a remote control device to toggle between the main programming guide and the ‘Favorites’ list. In another aspect, restrictions made to the main programming guide transfer to a ‘Favorites’ listing, such that a channel blocked at the main programming guide is absent from the ‘Favorites’ list. In another aspect, the backbone may provide the main programming guide and the ‘Favorites’ list to any device such as a remote computer, a Personal Digital Assistant (PDA), a cellular phone, etc. Such provision may be via a web portal sent by the application provider 150. The customer may access the portal utilizing a logon and providing the PIN number or another identifier recognized by the backbone 110 or the provider 150. The customer may then change the ‘Favorites’ list or lists and also block or unblock a channel via the remote device.

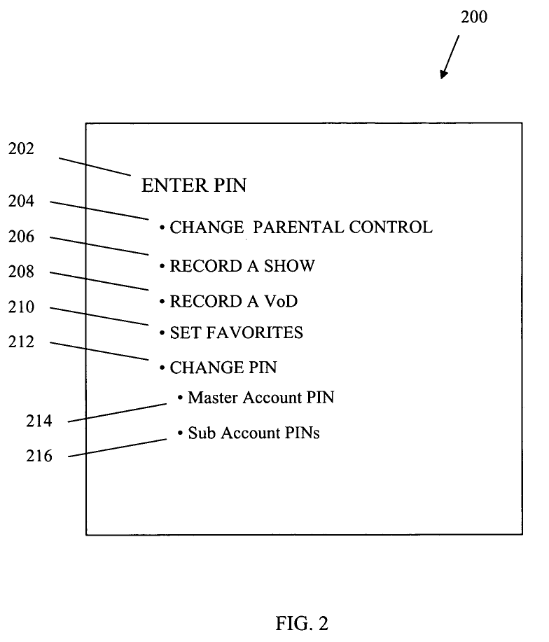

FIG. 2 illustrates an exemplary screenshot 200 displaying options available to a supervisor through an interface accessible by an STB or a remote device. The exemplary screen 200 includes an option to enter a PIN 202; change parental controls 204; record a show 206 such as a scheduled program, by setting channels and times or by selecting a program ID; record a VoD 208; set up or change a ‘Favorites’ list for a viewer account (i.e., a list of favorite channels of a viewer); and change the PIN(s) 212 of one or more viewer accounts, including the master account 214 and the viewer accounts (sub accounts) 216. Changes to PINs may be made to a group or category of viewer accounts (i.e., ‘Teens,’ ‘Children’) or to an individual viewer account. Confirmation of the action of resetting a PIN may be sent to a designated email account. As an example, a user may select settings to record a program or a VoD. The settings may be set through the STB or by using a remote device to access the database 184. Thus, a user may set the STB to record a program or VoD via a cell phone, PDA, computer or any other suitable device, while the user is away from the TV set.

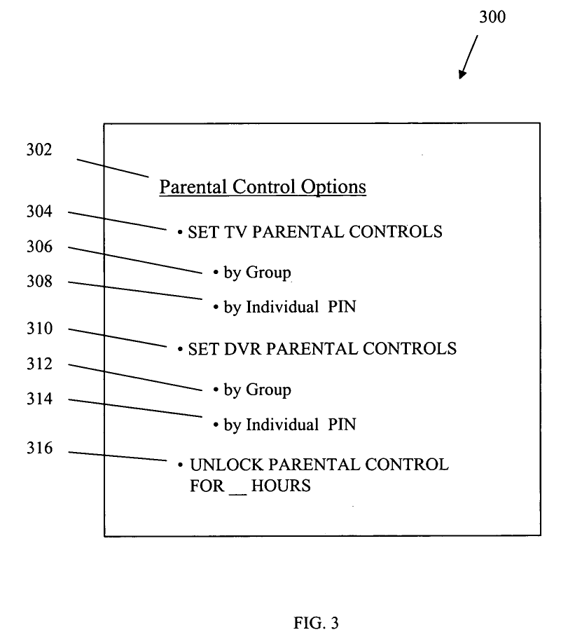

FIG. 3 illustrates an exemplary screenshot 300 for making changes to parental control settings. The screenshot is typically displayed once the ‘parent controls’ option (204) is selected from screen 200. The screen 300 includes a screen header 302; an option for setting a parental control for a television set 304; an option for setting parental controls at a DVR 310; and an option for unlocking parental controls for a specified amount of time 316. The option for setting parental controls may be performed for a category of viewers 306 or for individual viewers 308. Parental controls may be set for multiple STBs so that video content that is restricted at one television set, such as a television in a living room area, may be enabled at another television set, such as a television in a bedroom area. Where a customer location has multiple DVRs, parental control settings may be assigned individually to each of the multiple DVRs by selecting the appropriate options. Parental controls may be applied to DVR content by group or category or by each individual account 314. Separate parental controls are available for recording content to a recording device and viewing content at the television set. A log of changes and any overrides (such as unlocking parental controls) may be recorded and made available to an email account.

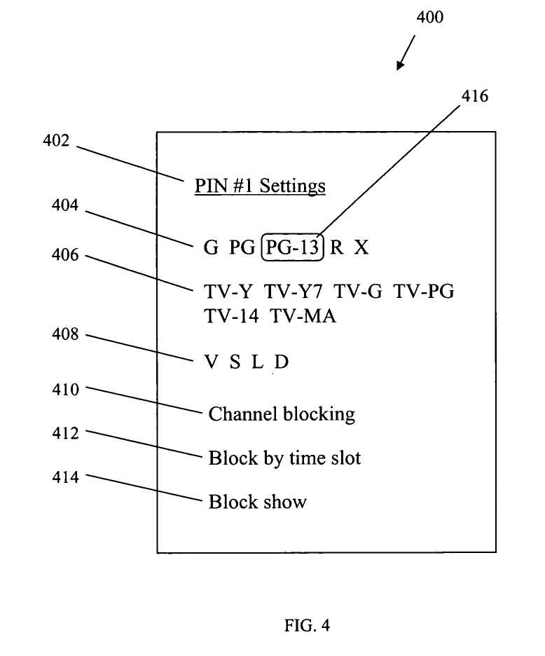

FIG. 4 shows a screenshot 400 of parental control settings of an individual account. The screenshot displays various ratings systems that may be used in connection with parental control settings. Some exemplary ratings systems are the MPAA ratings system 404, the television ratings system 406, and a ratings system identifying potentially objectionable content (V, S, L, D, FV) 408. A supervisor selects the rating level, thereby blocking content having that rating (or higher). In the exemplary screen 400, the supervisor has selected ‘PG-13’ 416 for the PIN#1 viewer, so that the PIN#1 viewer is restricted from viewing content rated at ‘PG-13’ (or higher). The supervisor may also select to block certain channels (i.e., HBO) from being viewed, or a certain show (i.e., Survivor) from being viewed. In another aspect, an account manager may restrict television viewing for a selected time period. In another aspect, a separate screen is provided that enables a separate set of parental control settings to apply towards recording content at a recording device.

In the present disclosure, the settings of the STB are integrated into database 184 and may be accessed through a suitable portal, such as the Yahoo! portal. A viewer using a remote device, such as computer 174, may access the setting at the database via the remote device and make any desired changes. Once changes have been made, those changes may be communicated from the database to the STB. For example, a viewer is out shopping and remembers that he would like to record a show on his DVR that is due to begin before he returns home. The viewer uses his cell phone (114 of FIG. 1) to establish a link to the backbone (110 of FIG. 1) via, for example, the screen illustrated in FIG. 2. By selecting an appropriate action (i.e., ‘Record a Show’ 206), he may be presented with a list of programs from which to make a selection. Once he makes his selection, the changes may be stored to the database and transmitted to the STB. The settings at the STB are updated to reflect the viewer selection.

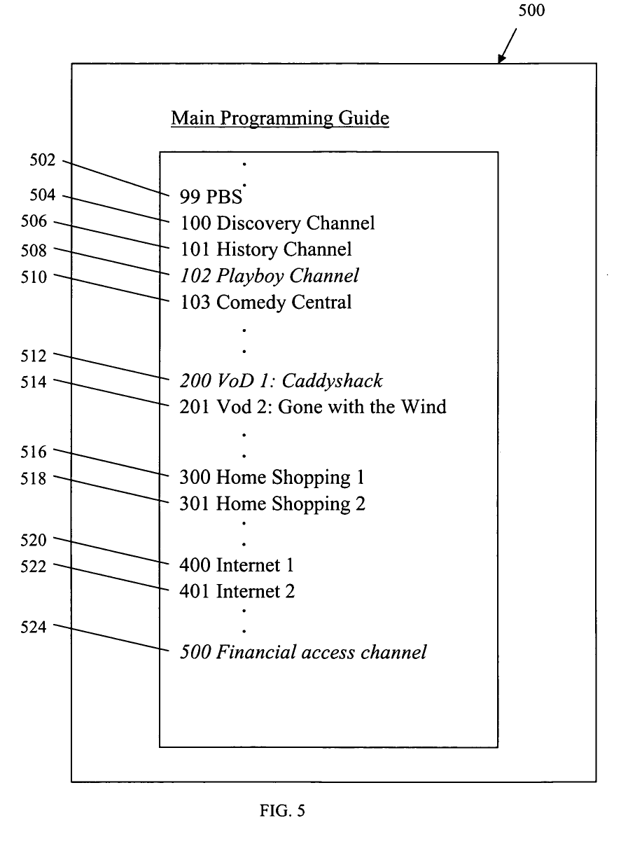

FIG. 5 illustrates an exemplary first list of names of channels, such as a main programming guide, in one aspect of the present disclosure. The exemplary main programming guide provides several channels available for viewing, including PBS 502, Discovery Channel 504, History Channel 506, Playboy Channel 508, and Comedy Central 510; several Video on Demand selections, such as Caddyshack 512 and Gone With the Wind 514; several interactive shopping channels, such as Home Shopping Network 1 516 and Home Shopping Network 2 518; and several Internet connections such as Internet 1 520 and Internet 2 522. The exemplary main programming guide also provides a Financial Access Channel 524 dedicated to providing access to financial matters of the viewer, such as bill payments, bank statements, etc. It is understood that additional network services suitable for the medium and not explicitly mentioned herein may be added to the main programming guide by adding a channel. In the example of FIG. 5, the Playboy Channel 508, Caddyshack 512, and the Financial Access Channel 524 have been restricted from being viewed. Thus, the names of the Playboy Channel 508, Caddyshack 512, and the Financial Access Channel 524 appear visually different than the names of the other (viewable) channels. In the example, the appearance of the blocked channels is altered through the use of italics. However, any number of ways of altering the appearance may be used, including altering the color, the size, the shading, the font, etc., of the name. In an alternative aspect, names of the blocked channels may not appear in the main programming guide.

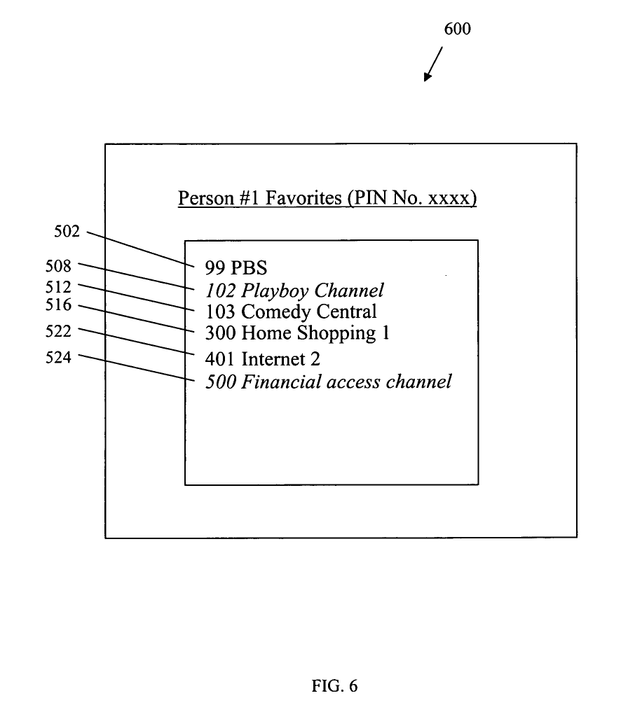

In the example of FIG. 5, channels blocked at one television set, such as in a living room, may be viewed at another television set, such as in a bedroom. FIG. 6 illustrates an exemplary ‘Favorites’ listing shown at a television set at which channels are not blocked (i.e., bedroom TV). The ‘Favorites’ list of FIG. 6 reflects the main programming guide as seen at the exemplary television set of the bedroom. For the purposes of illustration, the viewer has selected PBS 502, the Playboy Channel 508, Comedy Central 510, the Home Shopping Network 1 516, Internet 2 522, and Financial Access Channel 524 to appear in the ‘Favorites’ list. Thus these selections appear on the exemplary ‘Favorites’ list of FIG. 6 that may be viewed at the TV that does not have blocking.

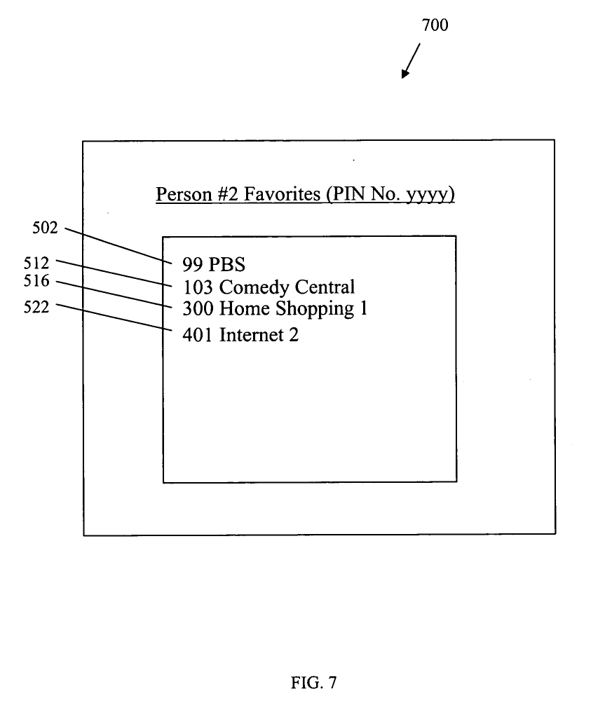

FIG. 7 shows the same ‘Favorites’ list of FIG. 6 as viewed from the television set of the living room at which parental control settings block certain channels. The blocked channels (i.e., Playboy Channel, Caddyshack, and Financial Access Channel) do not appear on the ‘Favorites’ list when the list is accessed from the television set in the living room. The viewer sees PBS 502, Comedy Central 512, Home Shopping Network 1 516 and Internet 2 522 at the living room set.

Another aspect of the disclosure provides a set of reports on viewer activity. The reports may cover a specified period, such as for the current month or for the last month or a specifiable historical perspective on viewing habits. Reports may be presented under a variety of formats and may categorize viewing habits according to several criteria, such as hours viewed per channel, hours viewed per genre, hours viewed per program, hours viewed per viewer, hours of games played, hours spent per application, etc.

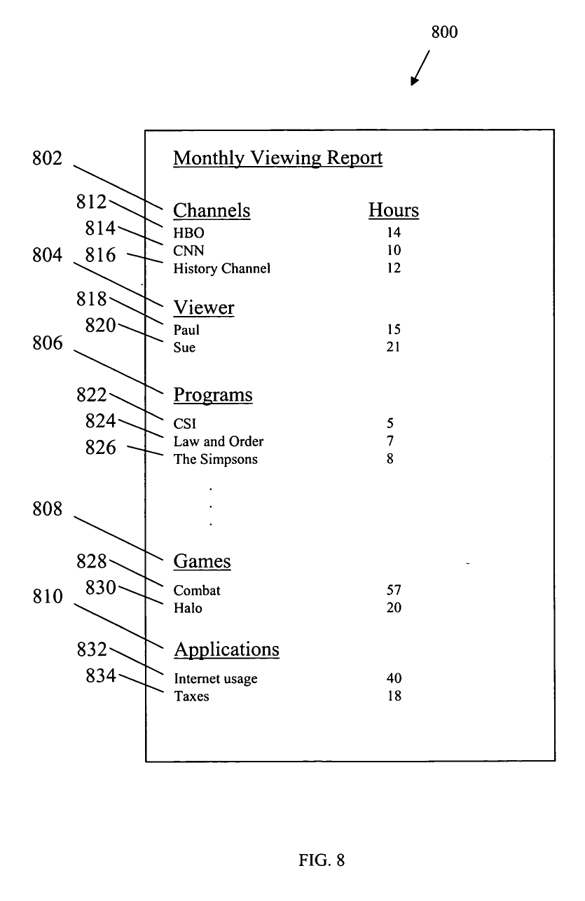

FIG. 8 shows an exemplary report 800 on viewer activity that may be provided in one aspect of the present disclosure. The exemplary report provides multiple categories for displaying viewer behavior, such as Channels 802, Viewers 804, Programs 806, Games 806, and Applications 808. Listings under Channels 802 indicate the amount of time spent watching various channels (i.e., HBO 712, CNN 814, History Channel 816). Listings under Viewers 804 indicate the amount of time spent watching TV per viewer. In the exemplary report, Paul (818) has spent 15 hours and Sue (820) has spent 21 hours. Listings under Programs 806 indicate the amount of time spent watching various programs. In the exemplary report, 5 hours of CSI (822) have been watched, 7 hours of Law and Order (824), 8 hours of The Simpsons (826), and so forth. Listings under Games indicate the amount of time spent playing network games (i.e., Combat 828, Halo 830, etc.). Listings under Applications indicate the amount of time spent using network applications, such as an Internet connection 832, or a tax preparation application 834.

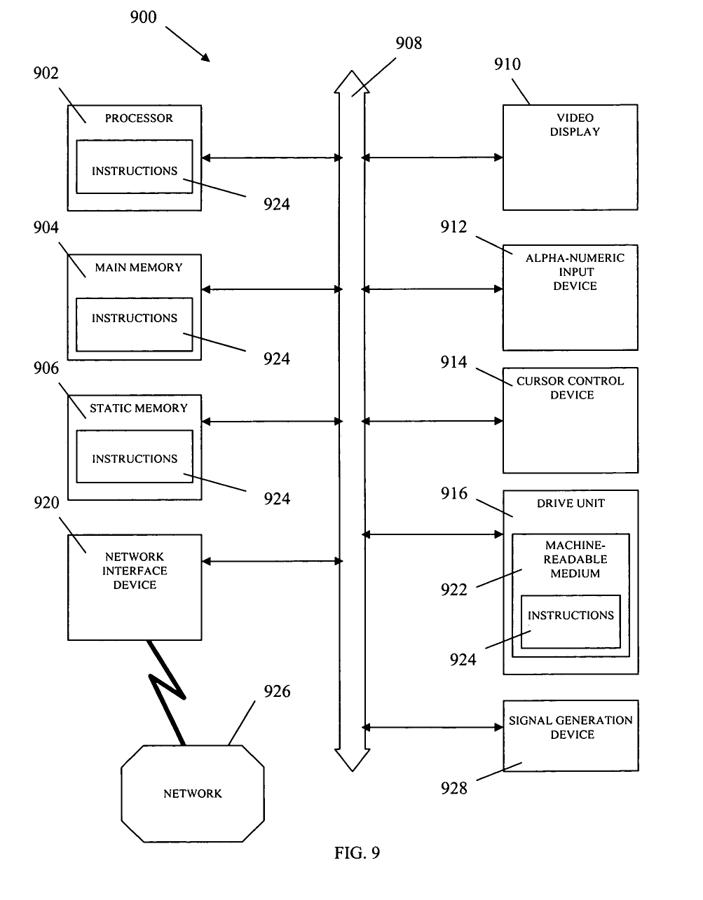

FIG. 9 is a diagrammatic representation of a machine in the form of a computer system 900 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 900 may include a processor 902 (e.g., a central processing unit (CPU), a graphics processing unit (GPU), or both), a main memory 904 and a static memory 906, which communicate with each other via a bus 908. The computer system 900 may further include a video display unit 910 (e.g., a liquid crystal display (LCD), a flat panel, a solid state display, or a cathode ray tube (CRT)). The computer system 900 may include an input device 912 (e.g., a keyboard), a cursor control device 914 (e.g., a mouse), a disk drive unit 916, a signal generation device 918 (e.g., a speaker or remote control) and a network interface device 920.

The disk drive unit 916 may include a machine-readable medium 922 on which is stored one or more sets of instructions (e.g., software 924) embodying any one or more of the methodologies or functions described herein, including those methods illustrated in herein above. The instructions 924 may also reside, completely or at least partially, within the main memory 904, the static memory 906, and/or within the processor 902 during execution thereof by the computer system 900. The main memory 904 and the processor 902 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 924, or that which receives and executes instructions 924 from a propagated signal so that a device connected to a network environment 926 can send or receive voice, video or data, and to communicate over the network 926 using the instructions 924. The instructions 924 may further be transmitted or received over a network 926 via the network interface device 920.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-readable medium accessible to a processor for executing instructions contained in a computer program embedded in the computer readable medium, the computer program comprising:
instructions to receive content over a television network for display on a television set corresponding to a customer identifier;
instructions to receive an input corresponding to the customer identifier to block a selected content from recording on a recording device; and
instructions to block the selected content from recording on the recording device in response to the received input.

2. The computer-readable medium of claim 1, wherein the computer program further comprises:
instructions to display the selected content on the television set while blocking the selected content from recording on the recording device.

3. The computer-readable medium of claim 1, wherein the computer program further comprises:
instructions to confirm the customer identifier before blocking the selected content from recording on the recording device.

4. The computer-readable medium of claim 1, wherein the selected content corresponds to one of: a rating; a video-on-demand (VOD); a pay-per-view (PPV) program; an age group; a time period of a day; a type of show; and a television channel.

5. The computer-readable medium of claim 1, wherein the input to block the selected content is received from one of: a remote control associated with a set-top-box (STB); a cellular telephone; a personal digital assistant (PDA); a computer via the Internet; and an Interactive Voice Recognition System

6. The computer readable medium of claim 1, wherein the customer identifier has at least one associated sub-account and wherein the computer program further comprises: instructions to block the selected channel corresponding to the at least one sub-account.

7. An apparatus for use in providing content received over a television network, comprising:
a first interface that provides content to a television set corresponding to a customer identifier;
a second interface that provides the content to a recording device; and
a processor for executing instructions contained in a computer program accessible to the processor, the computer program comprising:
instructions to receive an input corresponding to the customer identifier to block a selected content from recording on the recording device; and
instructions to block recording of the selected content in response to the received input.

8. The apparatus of claim 7, wherein the recording device is integral to the apparatus.

9. The apparatus of claim 7, wherein the computer program further comprises:
instructions to display the selected content on the television set while blocking the selected content from recording on the recording device.

10. The apparatus of claim 7, further comprising:
a memory that stores a list of programs that corresponds to the selected content and wherein the processor displays the list for viewing on the television set.

11. The apparatus of claim 10, wherein the computer program further comprises:
instructions to unblock recording of a program from the list of programs in response to an input corresponding to the customer identifier.

12. The apparatus of claim 7, wherein the selected content corresponds to on one of: a rating; a VoD content; a PPV content ; an age group; a time period of a day; a type of show; a television channel; a content that has a charge associated therewith.

13. The apparatus of claim 7, wherein the input is received from one of:
a remote control associated with the apparatus; cellular telephone; PDA; and computer via the internet.

14. A computer-readable medium accessible to a processor for executing instructions contained in a computer program embedded in the computer readable medium, the computer program comprising:
instructions to receive television content from a network corresponding to a customer identifier;
instructions to record a selected content from the received content in response to a first input corresponding to the customer identifier; and
instructions to block at least a portion of the recorded content from displaying on a television set in response to a second input corresponding to the customer identifier.

15. The computer-readable medium of claim 14, wherein the computer program further comprises:
instructions to unblock the at least a portion of the recorded content in response to a third input corresponding to the customer identifier.

16. The computer-readable medium of claim 14, wherein at least one of the first, second and third inputs is received from one of a: remote control associated with a customer premise equipment (CPE); cellular telephone; PDA; and computer.

17. A system for providing a television service, comprising:
a database that stores customer information, including a customer identifier;
a server linked to a CPE;
a computer readable medium accessible to the server to execute instructions contained in a computer program embedded in the computer-readable medium, the computer program comprising:
instructions to receive an input from a remote device corresponding to the customer identifier to block a selected content from a recording device associated with the CPE; and instructions to transmit information to the CPE to block the selected content from recording on the recording device.

18. The system of claim 17, wherein the computer program further comprises:
instructions to receive an input to unblock at least a portion of the selected content from recording on the recording device; and
instructions to unblock the at least a portion of the selected content from recording on the recording device in response to the input to unblock.

19. A method of providing a television service, comprising:
receiving content over a television network corresponding to a customer identifier;
receiving an input corresponding to the customer identifier to block recording of a selected content on a recording device; and
blocking the selected content from recording on the recording device.

20. The method of claim 19, further comprising:
providing the selected content to a television set while blocking the selected content from recording on the recording device.

21. The method of claim 19, further comprising unblocking the selected content from recording on the recording device in response to an input to unblock the selected content.

22. The method of claim 19, wherein the selected content is based on one of: rating;
VOD; PPV; age group; time of day; type of show; television channel; and monetary amount.

23. The method of claim 19, wherein the input to block the selected content is received from one of a: remote control associated with the CPE; cellular telephone; PDA; and computer.
